(19) United States
(12) Patent Application Publication
(10) Pub. No.: US 2024/0034477 A1
(43) Pub. Date: Feb. 1, 2024

(54) TEMPERATURE CONTROL SYSTEM AND TEMPERATURE CONTROL METHOD AND AIRCRAFT

(71) Applicant: HONDA MOTOR CO.,LTD., Tokyo (JP)

(72) Inventors: Masashi ETO, Saitama (JP); Akinori KITA, Saitama (JP); Shinji HOSHINO, Saitama (JP); Koji HOSONO, Saitama (JP)

(21) Appl. No.: 18/186,222

(22) Filed: Mar. 20, 2023

(30) Foreign Application Priority Data
Mar. 25, 2022 (JP) 2022-050951

(51) Int. Cl. B64D 27/24; B64D 33/08

(52) U.S. Cl. CPC B64D 27/24; B64D 33/08; B64D 2027/026

(57) ABSTRACT

In an aircraft that flies utilizing power generated by an engine or power charged in a battery, a temperature control system includes a battery that stores power for starting the engine and flying, a temperature adjusting apparatus for warming or cooling the battery by each of at least the power charged in the battery and power feeding from an external power source, and a control section for detecting presence or absence of the power feeding, and if the power feeding is present, controlling the apparatus to warm or cool the battery using the power feeding, and if the power feeding is absent, controlling the apparatus to warm or cool the battery using charged power of the battery. Even if the power feeding has been lost, it is possible to maintain a temperature and a state of charge of the battery enabling the engine to start and fly.

### CROSS-REFERENCE TO RELATED APPLICATIONS

The contents of the following Japanese patent application(s) are incorporated herein by reference:
NO. 2022-050951 filed in JP on Mar. 25, 2022

### BACKGROUND

### 1. Technical Field

The present invention relates to a temperature control system, a temperature control method, and an aircraft.

### 2. Related Art

Conventionally, a vertical takeoff and landing type aircraft (also referred to as a VTOL aircraft or simply an aircraft) that takes off and lands by elevating in a vertical direction using a plurality of takeoff and landing (VTOL) rotors arranged on the right and left sides of a fuselage, and flies in a horizontal direction using a cruising rotor arranged at a rear part of the fuselage has been known. Such aircraft charges power generated by a power generating apparatus using an engine in a battery, and flies by operating a plurality of rotors utilizing the power charged in that battery. Here, batteries tend to exert high performance in warmer temperatures, but are liable to deterioration in excessively warm temperatures. Therefore, an aircraft described in Patent Document 1 is equipped with a temperature control system for maintaining the temperature of a battery within a desired temperature range during parking of the aircraft.
Patent Document 1: Specification of US Patent Application Publication No. 2021/370786

### BRIEF DESCRIPTION OF THE DRAWINGS

FIG. 1 illustrates a configuration of an aircraft according to the present embodiment in a top view.

FIG. 2 illustrates a configuration of a high voltage system and a configuration of a communication system.

FIG. 3 illustrates functional configurations of a temperature control system and a control system according to the present embodiment.

FIG. 4 illustrates a flow of a temperature control method according to the present embodiment.

FIG. 5 illustrates an example of a temperature control on a battery (at normal times).

FIG. 6 illustrates an example of the temperature control on the battery (at the time of a first abnormality).

FIG. 7 illustrates an example of the temperature control on the battery (at the time of a second abnormality).

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

In the present specification, “equal to or greater (higher) than” and “greater (higher) than” can be replaced with each other. In addition, “equal to or less (lower) than” and “less (lower) than” can be replaced with each other.

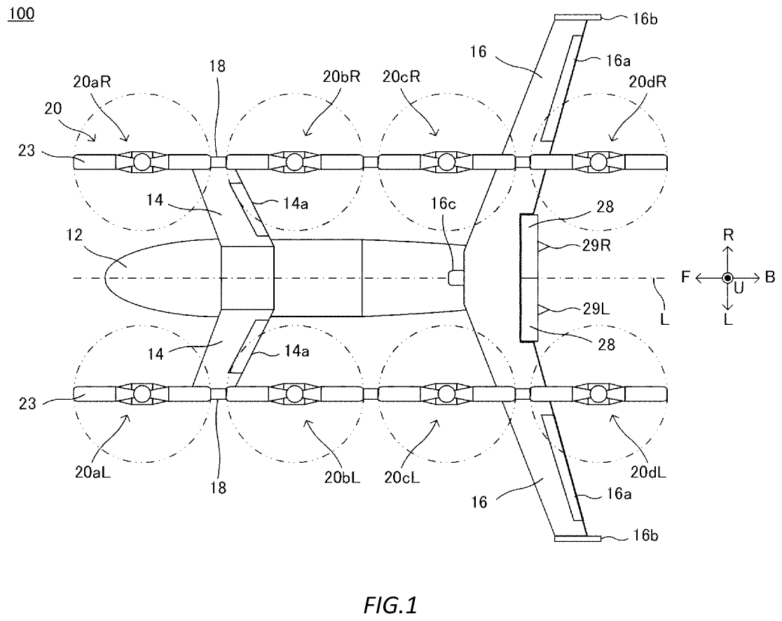

FIG. 1 illustrates a configuration of an aircraft 100 according to the present embodiment in a top view. The aircraft 100 is a vertical takeoff and landing aircraft including rotors having an electric motor as a driving source that takes off and lands in a vertical direction by generating a thrust using takeoff and landing rotors (also referred to as the VTOL rotors) 20 and flies in a horizontal direction by generating a thrust using cruising rotors (also referred to as the cruise rotors) 29, and is also a hybrid aircraft that operates an electric motor utilizing power generated by a power generating apparatus 40a (an engine 44 and a motor generator 42) and power charged in a battery 32 and that can charge the battery 32 with the engine 44.

The aircraft 100 according to the present embodiment is configured such that it can maintain a temperature and a state of charge (SOC) of an internal power source that allows the engine to start and fly at departure, even if power feeding from an external power source has been stopped, and the aircraft 100 includes a fuselage 12, a front wing 14, a rear wing 16, two booms 18, eight VTOL rotors 20, two cruising rotors 29, a cooling system 60, a temperature control system 70, a high voltage system 40, a communication system 49, and a control system 99.

The fuselage 12 is a structure that provides a space for boarding crews and passengers and loading cargoes and the like, and stores apparatuses such as the battery 32, the motor generator 42, and the engine 44. The fuselage 12 is symmetric relative to a central axis L, and has a shape that extends in a front-back direction that is parallel to the central axis L and is thin in a right-left direction that is orthogonal to the central axis L in the horizontal plane. Here, the direction parallel to the central axis L is defined as the front-back direction, in which the left side of the drawing and the right side of the drawing are respectively the front (F) and back (B), and the direction orthogonal to the central axis L in the horizontal plane is defined as the width direction (or the right-left direction), in which the upper side of the drawing and the lower side of the drawing are respectively the right (R) and left (L). In addition, the vertical direction is orthogonal to each of these front-back direction and the width direction, in which the upward and downward in the vertical direction are also respectively referred to as upper (U) and lower (L). The fuselage 12 has a front end with a round curvature in a top view, and a rear end parallel to the width direction that is tapered to some extent relative to the barrel portion.

The front wing 14 is a wing body provided to extend laterally from the fuselage 12, and configured to generate lift during cruise, that is, by moving forward, which functions as a canard of the aircraft 100. The front wing 14 has a V-shape with two wing bodies respectively extending from the center portion to the front-left direction and the front-right direction, and is fixed on the upper portion of the front side of the barrel portion of the fuselage 12 at the center portion with the opening of the V-shaping facing toward the front. The front wing 14 includes an elevator 14a arranged in a rear edge of each of the two wing bodies.

The rear wing 16 is a wing body provided to extend laterally from the fuselage 12, and configured to generate lift during cruise, that is, by moving forward, which functions as a swept-back wing configured to reduce air resistance. The rear wing 16 has a V-shape with two wing bodies respectively extending from the center portion to the back-left direction and the back-right direction, and is fixed on the upper portion of the rear end of the fuselage 12 at the center portion via a pylon 16c, with the opening of the V-shaping facing toward the back. The rear wing 16 includes an elevon 16a arranged in a rear edge of each of the two wing bodies, and a vertical tail 16b arranged at the wing tip.

Here, the wing area of the rear wing 16 is greater than that of the front wing 14, and the wing width of the rear wing 16 is wider than that of the front wing. In this manner, the lift generated by the rear wing 16 by moving forward is greater than the lift generated by the front wing 14, and the rear wing 16 functions as the main wing of the aircraft 100. Note that, the wing areas, the lengths or the like of the front wing 14 and the rear wing 16 may be defined based on the balance of the lift generated by each wing, the center of gravity, the posture of the aircraft body during cruise, and the like.

The two booms 18 are structures that are each supported by being separated to the right and left from the fuselage 12 by the front wing 14 and the rear wing 16, and have a function of supporting or storing constituent elements of the VTOL rotors 20 and the cooling system 60. The two booms 18 each have a cylindrical shape extending in the front-back direction in a top view and a wing-shaped cross section with the upper side having a round curvature and the lower side tapered in a front view, and are paired to be arranged symmetrically with respect to the fuselage 12 (that is, the central axis L). Note that, the two booms 18 may be formed to extend in the front-back direction and have an arch-shape curvature in the width direction. With regard to the two booms 18, front ends are positioned forward of the front wing 14 and are supported at the tips of the front wing 14 on the front side of the barrel portion (between two VTOL rotors 20aL, 20bL on the front side and between two VTOL rotors 20aR, 20bR on the front side), and back ends are positioned behind the rear wing 16 and are supported at the rear wing 16 on the back side of the barrel portion (between two VTOL rotors 20cL, 20dL on the back side and between two VTOL rotors 220cR, 20dR on the back side).

The eight VTOL rotors 20 (20aL to 20dL, 20aR to 20dR) have a propulsion system that generates a thrust in the vertical direction during takeoff and landing, while being supported by the two booms 18. Among the eight VTOL rotors 20, the four VTOL rotors 20aL to 20dL are supported at substantially equal intervals on the left-hand side boom 18, and the remaining four VTOL rotors 20aR to 20dR are supported at substantially equal intervals on the right-hand side boom 18. Here, with regard to the VTOL rotors 20aL to 20dL on the left-hand side, the VTOL rotor 20aL is arranged at the forefront, the two VTOL rotors 20bL, 20cL are arranged between the front wing 14 and the rear wing 16 at the front and back respectively, and the VTOL rotor 20dL is arranged at last. Similarly, with regard to the VTOL rotors 20aR to 20dR on the right-hand side, the VTOL rotor 20aR is arranged at the forefront, the two VTOL rotors 20bR, 20cR are arranged between the front wing 14 and the rear wing 16 at the front and back respectively, and the VTOL rotor 20dR is arranged at last. Among these four VTOL rotors 20aL to 20dL on the left-hand side and the four VTOL rotors 20aR to 20dR on the right-hand side, the respective two VTOL rotors 20aL, 20aR, VTOL rotors 20bL, 20bR, VTOL rotors 20cL, 20cR, and VTOL rotors 20dL, 20dR on the right and left having equal positions relating to the front-back direction are each paired, and are controlled so as to rotate in opposite directions from each other.

Note that, unless particularly stated, each of the eight VTOL rotors 20aL to 20dL, 20aR to 20dR is simply referred to as the VTOL rotor 20.

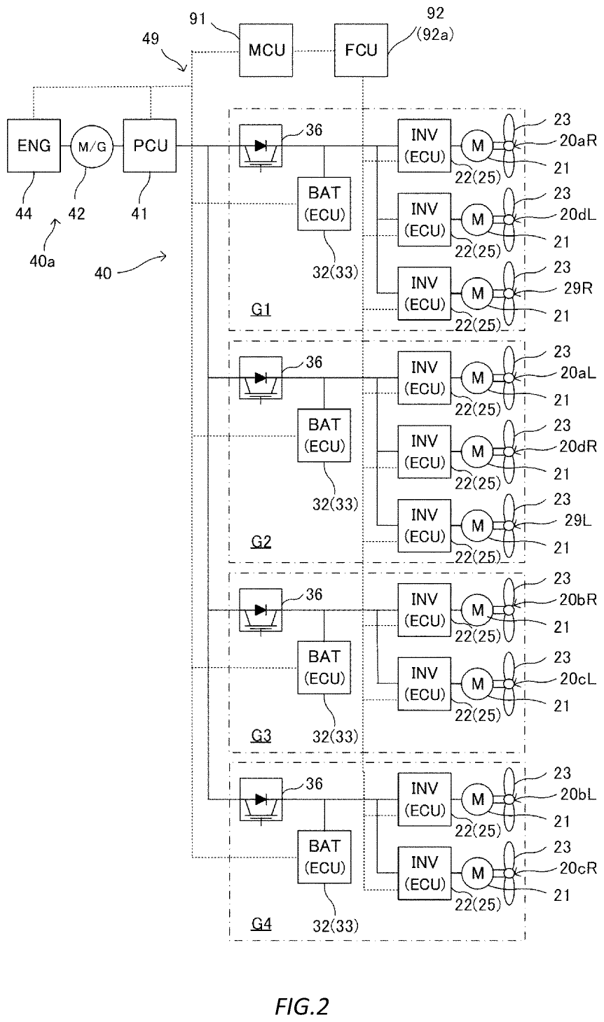

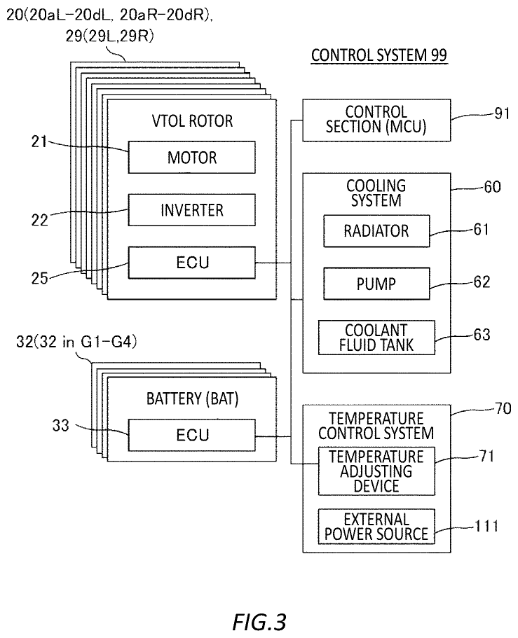

The VTOL rotor 20 has one or more blades 23, a motor 21, an inverter 22, and an ECU 25 (see FIG. 2 and FIG. 3). Note that, the motor 21 and the inverter 22 are also referred to as the electrical components.

The one or more blades 23 are blade-like members that are supported on the boom 18, for generating a thrust in the vertical direction by being rotated. In the present embodiment, the number of the blades 23 is two, but it may be any number including the number of one or three or more. The one or more blades 23 are supported at a position higher than the front wing 14 and the rear wing 16. Note that, in FIG. 1, the plane of rotation of the one or more blades 23 of each VTOL rotor 20 is illustrated by using two-dotted lines.

The motor 21 is an electric motor having an axis of rotation (not shown) directed in the up and down direction, that rotates the blades 23 fixed to the motor 21 via a transmission (not shown) for converting the number of rotations of the axis of rotation. The motor 21 is housed in the boom 18.

The inverter 22 is an apparatus that receives supply of DC power from the battery 32 via the high voltage system 40, and converts the DC power into AC power for supply to the motor 21 by driving (turning on/off) a switching element in accordance with a drive signal received from the ECU 25, and is housed in the boom 18 together with the motor 21. The inverter 22 can control the rotational torque and the rotation speed of the motor 21 respectively by increasing and decreasing the amplitude and frequency of the AC power.

The ECU (electronic control unit) 25 is a unit for modulating the amplitude and frequency of the AC power, by transmitting a drive signal to the inverter 22 thereby controlling its operation. In the present embodiment, the ECU 25 is provided for the inverter 22. The ECU 25 is implemented by a microcontroller as an example, and it operates by receiving DC power of a low voltage from the battery 32 via a low voltage system (also referred to as the LVS), and expresses a control function by executing a dedicated program stored in a memory.

The two cruising rotors 29 (29L, 29R) have a propulsion system for generating a thrust during cruise, while being supported at the rear end of the fuselage 12 (see FIG. 2). The cruising rotors 29L, 29R are arranged to the right and left relative to the central axis L within a cylindrical duct 28 fixed to the rear end of the fuselage 12, and the cruising rotors 29L, 29R have the one or more blades 23 supported within the duct 28 for generating a thrust to the forward by being rotated, the motor 21 having the axis of rotation directed in the front-back direction for rotating the one or more blades 23 fixed to the tip via this axis of rotation, the inverter 22 receiving supply of DC power from the battery 32 and converting it into AC power for supply to the motor 21, and the ECU 25 for controlling the operation of the inverter 22. The inverter 22 can control the rotation speed of the motor 21. These constituent elements are configured in the same manner as those in the VTOL rotor 20.

Note that, unless particularly stated, each of the two cruising rotors 29L, 29R is simply referred to as the cruising rotor 29. In addition, unless particularly stated, the VTOL rotor 20 and the cruising rotor 29 are collectively referred to as the rotors 20, 29.

The cooling system 60 is a system for cooling the motor 21 and the inverter 22 (which are also referred to as the electrical components) that constitute the VTOL rotor 20 in a liquid cooling manner by using a radiator 61 arranged within the boom 18. Although one cooling system 60 is provided for one VTOL rotor 20, and a total of eight cooling systems 60 are provided in the present embodiment, it is not limited thereto, and one cooling system 60 may be provided for a plurality of (for example, two) VTOL rotors 20. The cooling system 60 includes the radiator 61, a pump 62, and a coolant fluid tank 63. Note that a tube for transporting a coolant fluid is used to connect the radiator 61 and the pump 62 with the motor 21 and the inverter 22, thereby forming a cooling circuit in which the coolant fluid circulates.

The radiator 61 is a heat exchanger that cools a coolant fluid for cooling the motor 21 and the inverter 22. Water can be used as the coolant fluid.

The pump 62 is connected to the radiator 61 via the tube, and receives the coolant fluid that is cooled therefrom, and feeds the same to the motor 21 and the inverter 22. In accordance with this, the coolant fluid having been heated through the motor 21 and the inverter 22 is fed to the radiator 61 via the tube.

The coolant fluid tank 63 is a container for storing the coolant fluid. For example, in a case where there is a shortage of the coolant fluid, the coolant fluid is sent from the coolant fluid tank 63 to the cooling circuit to supplement the coolant fluid.

Note that a cooling system having a configuration similar to that of the cooling system 60 may be provided to cool the electrical components of the cruising rotor 29.

Note that, in the cooling system 60, the radiator 61, the pump 62, and the coolant fluid tank 63 may be arranged within the fuselage 12, and the radiator 61 and the pump 62 may be connected with the motor 21 and the inverter 22 using the tube, thereby circulating the coolant fluid via the tube to cool the motor 21 and the inverter 22. Furthermore, the radiator 61 and the pump 62 may be connected with the battery 32 using the tube, and the battery 32 may be cooled by circulating the coolant fluid via the tube.

The temperature control system 70 is a system for controlling the temperature of the battery 32. The temperature control system 70 includes the battery 32, a temperature adjusting apparatus 71, and an external power source 111.

The battery 32 is an internal power source that stores power for starting the engine 44 and flying. Here, the state of charge or the charge amount (or the charge rate) of the battery is referred to as the SOC (State Of Charge). The battery 32 is required to store a minimum charge amount needed to start the engine 44 (a startable charge amount, also referred to as the startable SOC) at the time of starting the engine 44, and a minimum charge amount needed to operate the VTOL rotor 20 and the cruising rotor 29 and generate a required thrust (a flyable charge amount, also referred to as the flyable SOC) at the time of flying the aircraft 100. Note that the startable charge amount is smaller than the flyable charge amount.

In addition, performance of the battery 32 is strongly dependent on its temperature. For example, the battery 32 outputs larger power in warmer temperatures, while outputting smaller power in cooler temperatures, and it hardly outputs power when being frozen. Accordingly, it is required that a temperature that allows output of minimum power needed to start the engine 44 (a startable temperature) is maintained at the time of starting the engine 44, and a temperature that allows output of minimum power needed to operate the VTOL rotor 20 and the cruising rotor 29 and generate a required thrust (a flyable temperature) is maintained at the time of flying the aircraft 100. Note that the startable temperature is lower than the flyable temperature.

The battery 32 will be further described below.

The temperature adjusting apparatus 71 is an example of a temperature adjusting unit, and is an apparatus that is controlled by a control section 91 to warm and keep the warmth of the battery 32 by each of at least power charged in the battery 32 and power feeding from the external power source 111. As the temperature adjusting apparatus 71, an Electric Coolant Heater (ECH) that heats water by utilizing electricity, and warms and keeps the warmth of an object by circulating the water can be applied. One temperature adjusting apparatus 71 may be provided for all the batteries 32, but not limited thereto, one temperature adjusting apparatus 71 may be provided for a plurality of the batteries 32, or one temperature adjusting apparatus 71 may be provided for each of all the batteries 32. Note that the temperature adjusting apparatus 71 can also be used for air conditioning of the inside of the aircraft body.

Note that the temperature control system 70 may be configured by including the cooling system 60. In this manner, not limited to warming or keeping the warmth of the battery 32 using the temperature adjusting apparatus 71, the temperature control system 70 may be further configured to cool the battery 32 using the cooling system 60 if the battery 32 is at a high temperature.

The external power source 111 is a power source that is provided in an area where the aircraft 100 is parked such as a hangar for storing the aircraft 100. The external power source 111 may be a power source of a low voltage system for supplying power to the temperature adjusting apparatus 71 for operation. By connecting the external power source 111 to the temperature adjusting apparatus 71 of the aircraft 100 during parking, it is possible to warm or keep the warmth of the battery 32 by operating the temperature adjusting apparatus 71 using power feeding from the external power source 111, thereby enabling maintenance of the temperature of the battery 32. At departure of the aircraft 100, the external power source 111 is removed from the aircraft 100 (the temperature adjusting apparatus 71).

FIG. 2 illustrates a configuration of the high voltage system (also referred to as the power distribution system (PDS)) 40 and a configuration of the communication system 49.

The high voltage system 40 is configured by including a pair of the power generating apparatuses 40a and four group components G1 to G4. Note that these constituent elements are connected via a power line (solid line).

The power generating apparatus 40a is a power source for generating power by using the engine 44 based on a target power generation amount and supplying the generated power to a load, and is configured by including the engine (ENG) 44, the motor generator (M/G) 42, and a power control unit (PCU) 41.

The engine 44 is an internal-combustion engine such as a reciprocating engine or a gas-turbine engine. The engine 44 generates rotational power, and outputs this to the motor generator 42.

The motor generator 42 is a motor generator that becomes a starter at the time of starting the engine 44, and becomes a generator after the engine 44 has been started. The axis of rotation of the motor generator 42 is coupled to an output axis of the engine 44. The motor generator 42 generates power, i.e., generates AC power (in particular, three-phase AC power) upon receiving motive power of the engine 44, and outputs this to the PCU 41. In addition, at the time of starting the engine 44, the motor generator 42 generates rotational power upon receiving AC power, and outputs this to the engine 44.

The PCU 41 is a power conversion unit that uses an inverter circuit to convert AC power (in particular, three-phase AC power) input from the primary side into DC power for output to the secondary side, and convert DC power input from the secondary side into AC power (in particular, three-phase AC power) for output to the primary side. A primary-side terminal of the PCU 41 is connected to the motor generator 42, and a secondary-side terminal is connected to each of the four group components G1 to G4. The PCU 41 can convert AC power output from the motor generator 42 into DC power for output to each of the four group components G1 to G4, and can convert DC power supplied from the battery 32 included in the four group components G1 to G4 into AC power for output to the motor generator 42.

Each of the four group components G1 to G4 is a group of electric components assembled by including any two of the eight VTOL rotors 20, the group components G1 to G2 further including any one of the two cruising rotors 29, and the battery 32 and a switch 36 accompanying these rotors. Note that these components including the battery 32 are connected via circuit elements such as a power line (a power cable shown with the solid line), a conductor, and a diode.

The group component G1 includes the VTOL rotors 20aR, 20dL, the cruising rotor 29R, the battery 32, and the switch 36.

As mentioned above, the VTOL rotors 20aR, 20dL and the cruising rotor 29R each has the motor 21 for rotating the one or more blades 23, and the inverter 22 for receiving DC power supply from the battery 32 and converting it into AC power for supply to the motor 21. These three rotors 20, 29 are connected in parallel with respect to the battery 32.

The battery 32 is an internal power source that stores power for starting the engine 44 and flying. The battery 32 is a power source for storing power generated by the engine 44 and the motor generator 42, and transmitting the power to the motor 21 via the inverter 22. The battery 32 is connected between the three rotors 20, 29 described above and the switch 36. The battery 32 is managed with an ECU 33 provided thereto.

The ECU 33 is a unit for managing the state of the battery 32. The ECU 33 is implemented by a microcontroller as an example, and it operates by receiving DC power of a low voltage from the battery 32 via the low voltage system, and expresses a control function by executing a dedicated program stored in a memory. Here, the state of the battery 32 includes at least the temperature and the state of charge (SOC). The ECU 33 detects the temperature of the battery 32 with a temperature sensor provided for the battery 32. Any type of sensor such as, for example, a temperature resistance element (thermistor) or a thermocouple can be used as the temperature sensor, as long as it can detect the temperature within a temperature range during operation and stoppage of the battery 32 (for example, −45 to 45 degrees C.). In addition, the ECU 33 detects the state of charge of the battery 32 by any method such as detecting current output from the battery 32 and calculating its integrated quantity, or detecting an electrical potential of an output terminal. Those detection results are sent to the control section 91 via the communication line.

The switch 36 is an element for connecting the group component G1 to the secondary-side terminal of the PCU 41 and shutting down the connection, and as an example, is configured by including a rectifier element (diode) and a switching element that are connected in parallel. The rectifier element is an element that allows passage of only power directed to the inside of the group component G1 from the PCU 41. The switching element is an element that short-circuits both ends of the rectifier element, and for example, an element such as an insulated gate bipolar transistor (IGBT) can be used. By turning off the switch 36 (switching element), DC power output from the PCU 41 can be transmitted to the battery 32 and the three rotors 20, 29 via the rectifier element, and by turning on the switch 36, the DC power can be transmitted from the battery 32 to the PCU 41 via the switching element.

The group component G2 includes the VTOL rotors 20aL, 20dR, the cruising rotor 29L, the battery 32, and the switch 36. Each of these units is configured in the same manner as those described above.

The group component G3 includes the VTOL rotors 20bR, 20cL, the battery 32, and the switch 36. Each of these units is configured in the same manner as those described above.

The group component G4 includes the VTOL rotors 20bL, 20cR, the battery 32, and the switch 36. Each of these units is configured in the same manner as those described above.

With the configuration of the high voltage system 40 described above, the engine 44 and the motor generator 42 can output the generated power to the battery 32 and the inverter 22. In addition, when the switch 36 is turned on, the motor generator 42 can operate using power supplied from the battery 32, and can run the engine 44.

The communication system 49 includes a flight controller (FCU) 92, the control section (MCU) 91, four ECUs 33 respectively connected to the batteries 32 included in the group components G1 to G4, and ten ECUs 25 respectively connected to the inverters 22. These are communicably connected to one another via the communication line (dotted line).

The flight controller 92 is a unit for controlling operations of the constituent elements upon receiving an operation signal from a crew of the aircraft 100 via an interface 92a such as a steering stick or a thrust lever. The flight controller 92 is connected to the control section 91 and each of the ten ECUs 25 via the communication line. The flight controller 92 is implemented by a microcontroller as an example, and it operates by receiving DC power of a low voltage from the battery 32 via the low voltage system, and expresses a control function by executing a dedicated program stored in a memory.

For example, upon receiving a command relating to steering of the aircraft 100, a command to takeoff or cruise, or the like via the interface 92a, the flight controller 92 calculates a required thrust (also referred to as the thrust command value) of each of the VTOL rotors 20 and the cruising rotors 29 and a power amount needed to generate each thrust, and transmits them to the motor generator 42, the PCU 41, and the ECU 33 via the control section 91, thereby generating power required to operate the rotors 20, 29. Together with this, by transmitting the thrust command value (or the number of rotations of the rotors 20, 29 needed to generate the thrust) to the ECU 25, the switching element of the inverter 22 is operated, and DC power output from the PCU 41 or DC power supplied from the battery 32 is converted into AC power for output to the motor 21. In this manner, the motor 21 actuates and the blade 23 rotates, and the commanded thrusts can be generated in the VTOL rotor 20 and the cruising rotor 29.

The control section (MCU) 91 communicates with the switch 36 to control the operation of its switching element, communicates with the engine 44 to control its starting, and communicates with the PCU 41 to control the operation of its switching element, and communicates with the ECU 33 to detect the state of the battery 32. The control section 91 is connected to the engine 44, the PCU 41, and each of the four switches 36 and the four ECUs 33 via the communication line. The control section 91 is implemented by a microcontroller as an example, and it operates by receiving DC power of a low voltage from the battery 32 via the low voltage system, and expresses a control function by executing a dedicated program stored in a memory.

The control section 91 controls the operation of the power generating apparatus 40a based on, in particular, detection results of the state of charge and the temperature of the battery 32 by the ECU 33 and a target power feeding amount received from the flight controller 92.

The four ECUs 33 and the ten ECUs 25 are configured in the manner as mentioned above.

In the high voltage system 40 configured in the manner as described above, upon receiving an operation by a crew of the aircraft 100, for example, a command to start the engine via the flight controller 92, the control section 91 turns on the switch 36 of at least one of the group components G1 to G4, and connects the battery 32 included in that group component to the PCU 41. In this manner, the power charged in the battery 32 is supplied to the PCU 41. Therefore, the control section 91 operates the PCU 41. The PCU 41 converts DC power supplied from the battery 32 into AC power, and outputs the AC power to the motor generator 42. In this manner, the motor generator 42 is operated, and the engine 44 is started.

Once the engine 44 has been started, the control section 91 turns off the switch 36. In this state, the motor generator 42 generates power upon receiving motive power of the engine 44. The generated AC power is converted into DC power by the PCU 41, and is supplied to each of the group components G1 to G4. In this manner, the VTOL rotor 20 and the cruising rotor 29 are operated, and the battery 32 is charged.

Note that, during operations of the VTOL rotor 20 and the cruising rotor 29, the switch 36 of each of the group components G1 to G4 is turned off, and thus it is possible to prevent power supply from the battery 32 within a certain group component to another group component.

FIG. 3 illustrates a functional configuration of the control system 99 of the aircraft 100. The control system 99 includes the control section 91, the cooling system 60 for cooling the electric components of the VTOL rotor 20, and the temperature control system 70 for controlling the temperature of the battery 32. The VTOL rotor 20 includes the eight VTOL rotors 20aL to 20dL, 20aR to 20dR. Furthermore, it may also include the cruising rotors 29L, 29R. These are collectively referred to as the VTOL rotor 20, and one cooling system 60 that is correspondingly provided is illustrated. The battery 32 includes four batteries 32 included in each of the group components G1 to G4.

The control section 91 controls the operations of the VTOL rotor 20, the cruising rotor 29, the cooling system 60, and the temperature control system 70. The control section 91 is configured in the manner as mentioned above.

As mentioned above, with the temperature control system 70, the temperature of the battery 32 can be maintained by operating the temperature adjusting apparatus 71 using power feeding from the external power source 111, and warming and keeping the warmth of the battery 32 during parking of the aircraft 100. However, at an abnormality when power feeding from the external power source 111 has been stopped due to power outage or the like, the battery 32 cannot be warmed or the warmth cannot be kept, and thus there is a risk of affecting a flight plan.

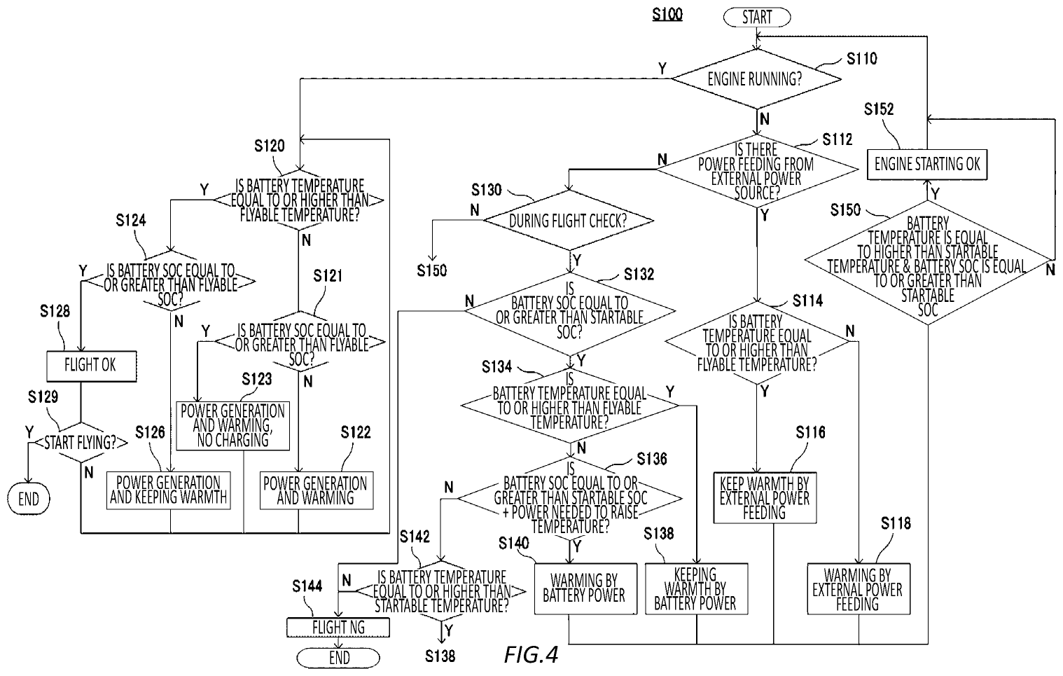

FIG. 4 illustrates a flow S100 of a temperature control method for controlling the temperature of the battery 32 in the aircraft 100 according to the present embodiment. This flow is started by, for example, storing the aircraft 100 in a hangar, and connecting the external power source 111 to the temperature adjusting apparatus 71 of the aircraft 100. Note that a self-discharge of the battery 32 can be ignored.

In step S110, the control section 91 determines whether the engine 44 is running. If the engine 44 is running, the process shifts to step S120, and if it is during stoppage, the process proceeds to step S112.

In step S112, the control section 91 determines the presence or absence of power feeding from the external power source 111. The presence or absence of power feeding can be determined by detecting whether the external power source 111 is connected to the temperature adjusting apparatus 71, and power is supplied from the external power source 111 to the temperature adjusting apparatus 71 (or whether there is flow of current). If the power feeding from the external power source 111 is present, the process proceeds to step S114, and if the power feeding from the external power source 111 is absent, the process shifts to step S130.

In steps S114 to S118, the control section 91 warms or keeps the warmth of the battery 32 by utilizing power feeding from the external power source 111.

In step S114, the control section 91 determines whether the temperature of the battery 32 is equal to or higher than the flyable temperature. As mentioned above, the temperature of the battery 32 is detected with the ECU 33, and the detection result is transmitted to the control section 91. The control section 91 can determine, based on the detection result received from the ECU 33, whether the temperature of the battery 32 is equal to or higher than the flyable temperature. In response to that determination, the control section 91 can control the temperature adjusting apparatus 71, and warm or keep the warmth of the battery 32 using power feeding from the external power source 111. If the temperature of the battery 32 is equal to or higher than the flyable temperature, the process proceeds to step S116, and if the temperature of the battery 32 is lower than the flyable temperature, the process proceeds to step S118.

In step S116, the control section 91 controls the temperature adjusting apparatus 71, and keeps the warmth of the battery 32 using power feeding from the external power source 111. In this manner, the temperature of the battery 32 is maintained equal to or higher than the flyable temperature.

In step S118, the control section 91 controls the temperature adjusting apparatus 71, and warms the battery 32 using power feeding from the external power source 111. In this manner, the temperature of the battery 32 is raised until the determination in step S114 becomes positive, i.e., to the flyable temperature.

Note that, if the power feeding from the external power source 111 is present, in response to the temperature of the battery 32 being equal to or higher than an upper limit temperature thereof, the control section 91 may control the cooling system 60 to operate the cooling system 60 using power feeding from the external power source 111, thereby cooling the battery 32. In this manner, the temperature of the battery 32 is maintained within a preferable temperature range. Here, the upper limit temperature of the battery 32 is the upper limit of the temperature in which the battery 32 normally functions, and it is higher than the startable temperature and the flyable temperature.

Once steps S116, S118 are completed, the process proceeds to step S150.

In steps S130 to S144, with the absence of power feeding from the external power source 111, the control section 91 controls the temperature adjusting apparatus 71 based on the temperature state and the state of charge (SOC) of the battery 32, and warms or keeps the warmth of the battery 32 using the charged power of the battery 32.

In step S130, the control section 91 determines whether it is during a flight check that is performed before or after the time which is predetermined from an expected time of departure. Here, the flight check includes all of the preflight check, the system check, and the flight check, which will be described below. However, the flight check may include at least one of them, such as only the preflight check. Whether it is during the flight check can be determined by, for example, detecting whether there is an operation for the check by a maintenance crew or a crew via the interface 92a. If it is not during the flight check, the process proceeds to step S150, and if it is during the flight check, the process proceeds to step S132.

In step S132, the control section 91 determines whether the charged power of the battery 32 is equal to or greater than the startable charge amount (less than the startable charge amount). The state of charge of the battery 32 is detected with the ECU 33, and the detection result is transmitted to the control section 91. The control section 91 can determine, based on the detection result received from the ECU 33, whether the charged power of the battery 32 is equal to or greater than the startable charge amount. If the charged power of the battery 32 is less than the startable charge amount, the process proceeds to step S144, and if the charged power of the battery 32 is equal to or greater than the startable charge amount, the process proceeds to step S134.

Note that, in determination on the charge amount of the battery 32 in step S132, instead of the startable charge amount, an amount that is slightly larger than this may be used as the threshold to certainly leave the startable charge amount. The same applies to other determination steps.

In step S134, the control section 91 determines whether the temperature of the battery 32 is equal to or higher than the flyable temperature (lower than the flyable temperature). The temperature of the battery 32 is detected with the ECU 33, and the detection result is transmitted to the control section 91. The control section 91 can determine, based on the detection result received from the ECU 33, whether the temperature of the battery 32 is equal to or higher than the flyable temperature. If the temperature of the battery 32 is equal to or higher than the flyable temperature, the process proceeds to step S138, and if the temperature of the battery 32 is lower than the flyable temperature, the process proceeds to step S136.

In step S138, in response to the temperature of the battery 32 being equal to or higher than the flyable temperature, the control section 91 controls the temperature adjusting apparatus 71 to keep the warmth of the battery 32 using the charged power of the battery 32. Accordingly, from the determinations in steps S112, S130, S132, S134, if the power feeding from the external power source 111 is absent, in response to the charged power of the battery 32 being equal to or greater than the startable charge amount and the temperature of the battery 32 being equal to or higher than the flyable temperature at the time of the flight check, the control section 91 controls the temperature adjusting apparatus 71 to keep the warmth of the battery 32 using the charged power of the battery 32.

Note that the power needed to keep the warmth of the battery 32 is significantly smaller than the power needed for warming. Therefore, for simplicity, in the present example, it is assumed that the charged power of the battery 32 does not decrease when keeping the warmth of the battery 32 using the charged power of the battery 32.

In step S136, the control section 91 determines whether the charged power of the battery 32 is equal to or greater than the sum of the startable charge amount and the power needed to raise the temperature of the battery 32 to at least the startable temperature enabling the engine 44 to start (the power needed to raise the temperature). The state of charge of the battery 32 can be detected in the manner as mentioned above. If the charged power of the battery 32 is equal to or greater than the sum of the startable charge amount and the power needed to raise the temperature, the process proceeds to step S140, and if it is less than the sum, the process proceeds to step S144.

In step S140, in response to the temperature of the battery 32 being lower than the flyable temperature and the charged power of the battery 32 being equal to or greater than the sum of the startable charge amount and the power needed to raise the temperature, the control section 91 controls the temperature adjusting apparatus 71 to warm the battery 32 using the charged power of the battery 32. In this manner, it is possible to secure a charged power of the battery 32 that is equal to or greater than the startable charge amount needed to start the engine 44, while also warming the battery 32.

Note that, if the power feeding from the external power source 111 is absent, in response to the temperature of the battery 32 being equal to or higher than the upper limit temperature, the control section 91 may control the cooling system 60 to operate the cooling system 60 using the charged power of the battery 32, thereby cooling the battery 32. In this manner, the temperature of the battery 32 is maintained within a preferable temperature range.

Once steps S138, S140 are completed, the process proceeds to step S150.

In step S142, the control section 91 determines whether the temperature of the battery 32 is equal to or higher than the startable temperature (lower than the startable temperature). The temperature of the battery 32 can be detected in the manner as mentioned above. If the temperature of the battery 32 is equal to or higher than the startable temperature, the process proceeds to step S138 to control the temperature adjusting apparatus 71 and keep the warmth of the battery 32 using the charged power of the battery 32, and if the temperature of the battery 32 is lower than the startable temperature, the process proceeds to step S144.

In step S144, in response to the determination that the charged power of the battery 32 is less than the startable charge amount in step S132, or the determination that the charged power of the battery 32 is less than the sum of the startable charge amount and the power needed to raise the temperature in step S136, and the determination that the temperature of the battery 32 is lower than the startable temperature in step S142, the control section 91 gives a signal for restricting the flight of the aircraft 100, and ends the flow S100.

In steps S150 to S152, the control section 91 determines whether to permit the start of the engine 44.

In step S150, the control section 91 determines whether the temperature of the battery 32 is equal to or higher than the startable temperature, and the charged power of the battery 32 is equal to or greater than the startable charge amount. As mentioned above, the temperature and the state of charge of the battery 32 are detected with the ECU 33, and the detection results are transmitted to the control section 91. The control section 91 can determine, based on the detection results received from the ECU 33, whether the temperature of the battery 32 is equal to or higher than the startable temperature, and the charged power of the battery 32 is equal to or greater than the startable charge amount. If the temperature of the battery 32 is equal to or higher than the startable temperature, and the charged power of the battery 32 is equal to or greater than the startable charge amount, the process proceeds to step S152, and if not, the process returns to step S110.

In step S152, the control section 91 gives a signal for permitting the start of the engine 44 to the crew of the aircraft 100. The signal can be expressed by lighting of a lamp, a voice, a screen display, or the like. Upon confirming the signal, the crew can start the engine 44 via the interface 92a.

In steps S120 to S129, the control section 91 performs a recovery procedure of the battery state due to the starting of the engine.

In step S120, during running of the engine 44, the control section 91 further determines whether the temperature of the battery 32 is equal to or higher than the flyable temperature. The temperature of the battery 32 can be detected in the manner as mentioned above. In response to that determination, the control section 91 can control the temperature adjusting apparatus 71, and warm or keep the warmth of the battery 32 using the power generated by the engine 44 (and the motor generator 42). If the temperature of the battery 32 is lower than the flyable temperature, the process proceeds to step S121, and if the temperature of the battery 32 is equal to or higher than the flyable temperature, the process proceeds to step S124.

In step S121, the control section 91 determines whether the charged power of the battery 32 is equal to or greater than the flyable charge amount. The state of charge of the battery 32 can be detected in the manner as mentioned above. If the charged power of the battery 32 is less than the flyable charge amount, the process proceeds to step S122, and if the charged power of the battery 32 is equal to or greater than the flyable charge amount, the process proceeds to step S123.

In step S122, since the temperature of the battery 32 is lower than the flyable temperature and the charged power of the battery 32 is less than the flyable charge amount, the control section 91 controls the temperature adjusting apparatus 71 to charge the battery 32 while warming the battery 32 using the power generated by the engine 44.

In step S123, since the temperature of the battery 32 is lower than the flyable temperature and the charged power of the battery 32 is equal to or greater than the flyable charge amount, the control section 91 controls the temperature adjusting apparatus 71 to warm the battery 32 using the power generated by the engine 44. However, the battery 32 is not charged.

With step S122 or S123, the temperature of the battery 32 is raised until the temperature of the battery 32 exceeds the flyable temperature and the determination in step S120 becomes positive.

In step S124, the control section 91 determines whether the charged power of the battery 32 is equal to or greater than the flyable charge amount. The state of charge of the battery 32 can be detected in the manner as mentioned above. If the charged power of the battery 32 is less than the flyable charge amount, the process proceeds to step S126, and if the charged power of the battery 32 is equal to or greater than the flyable charge amount, the process proceeds to step S128.

Note that, in the determination on the charge amount of the battery 32 in step S124, instead of the flyable charge amount, an amount that is slightly larger than this may be used as the threshold to certainly leave the flyable charge amount. The same applies to other determination steps.

In step S126, since the temperature of the battery 32 is equal to or higher than the flyable temperature and the charged power of the battery 32 is less than the flyable charge amount, the control section 91 controls the temperature adjusting apparatus 71 to charge the battery 32 while keeping the warmth of the battery 32 using the power generated by the engine 44.

Note that, if the engine 44 is running, in response to the temperature of the battery 32 being equal to or higher than the upper limit temperature of the battery 32, the control section 91 may control the cooling system 60 to operate the cooling system 60 using the power generated by the engine 44, thereby cooling the battery 32. In this manner, the temperature of the battery 32 is maintained within a preferable temperature range.

Note that step S120 and step S124 may be performed in reverse order. That is, the battery 32 may be charged first, and the battery 32 may be warmed once the charged power of the battery 32 exceeds the flyable charge amount.

Once steps S122, S123, S126 are completed, the process returns to step S120.

In step S128, since the temperature of the battery 32 is equal to or higher than the flyable temperature and the charged power of the battery 32 is equal to or greater than the flyable charge amount, the control section 91 gives a signal for permitting the flight of the aircraft 100 to the crew of the aircraft 100. The signal can be expressed by lighting of a lamp, a voice, a screen display, or the like. Upon confirming the signal, the crew can start the flight via the interface 92a.

Since the process cannot proceed to step S128 unless the determinations in steps S120, S124 become positive, if the temperature of the battery 32 is lower than the flyable temperature or the charged power of the battery 32 is less than the flyable charge amount, the flight cannot be started.

In step S129, the control section 91 determines whether the flight of the aircraft 100 has been started. The start of the flight can be detected by an input of a flight command by the crew via the interface 92a, or by detecting the operations of the rotors 20, 29. If the flight has not been started, the process returns to step S120, and steps S120 to S128 will be repeated. If the flight has been started, the flow S100 ends.

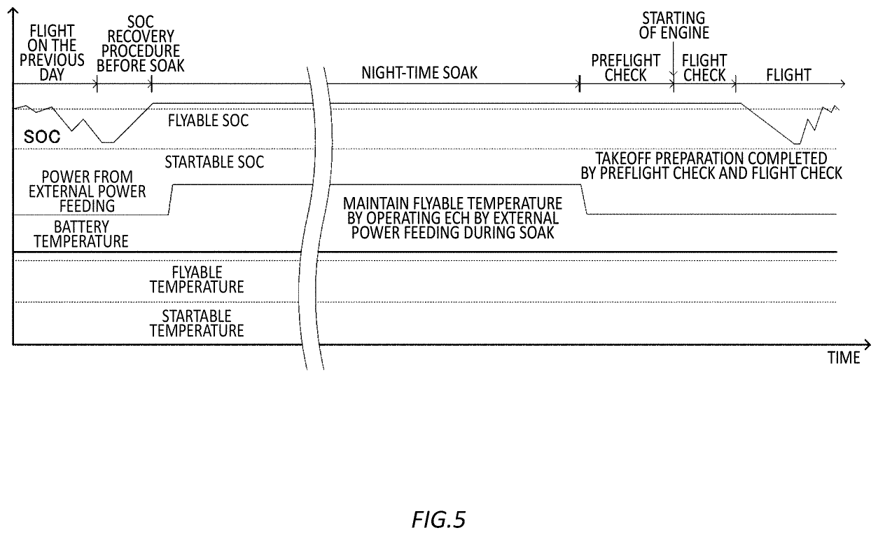

FIG. 5 illustrates an example of the temperature control on the battery 32 at normal times when power feeding from the external power source 111 has not been lost. The aircraft 100 completes the flight schedule on the previous day, and is stored in a hangar. After this, the state of charge of the battery 32 is recovered before soaking (stopping the engine 44), and the engine 44 is stopped while connecting the external power source 111 to the temperature adjusting apparatus 71 of the aircraft 100, thereby entering night-time soak. In the present example, with the continuance of power feeding from the external power source 111 after stopping the engine 44, during the night-time soak, the determination in step S110 becomes negative and the determination in step S112 becomes positive in the flow S100, and thus steps S114 to S118 and S150 to S152 will be repeated. In this manner, the temperature of the battery 32 is maintained equal to or higher than the flyable temperature, and the charged power of the battery 32 is maintained equal to or greater than the flyable charge amount. Note that a self-discharge of the battery 32 can be ignored.

On the day of the flight, the preflight check, the system check, and the flight check of the aircraft are performed before the time predetermined from an expected time of departure. In the preflight check, for example, one maintenance crew spends about an hour to check the equipment such as a fire extinguisher, check the power source system, check the appearance of the aircraft body, check the sensor, check the driving parts of the rotors 20, 29, check the oil, the coolant fluid, the warming fluid, etc., check the fuel, check the interface 92a, and the like.

The system check is a check that is performed after the preflight check, before the flight, and for example, two crews spend several minutes to check the power source, check the warning sound, check the fuel system, check the air conditioning system, check the interface 92a such as a steering stick, and the like. After completion of the system check, the crew runs the engine 44. Furthermore, the engine 44, the number of rotations of the rotors 20, 29, the temperature, the pressure, and the like are checked.

The flight check is a final check that is performed immediately before departure, and for example, two crews spend 1 to 2 minutes to check the warning and steering functions, the engine 44, the number of rotations of the rotors 20, 29, the temperature, the pressure, and the like. Upon completion of the flight check, the flight can be started.

In the present example, at the time of starting the preflight check, the external power source 111 is removed from the aircraft 100 (the temperature adjusting apparatus 71). In this manner, the determination in step S112 in the flow S100 becomes negative, and the process shifts to step S130. Here, with the temperature of the battery 32 being maintained equal to or higher than the flyable temperature and the charged power of the battery 32 being maintained equal to or greater than the flyable charge amount, the determinations in steps S132 to S134, S150 all become positive, and the start of the engine 44 will be permitted by the control section 91 in step S152. Upon that permission, after completion of the preflight check (the system check), the engine 44 will be started by the crew.

Once the engine has been started, the determination in step S110 becomes positive, and the process shifts to step S120. Here, with the temperature of the battery 32 being maintained equal to or higher than the flyable temperature and the charged power of the battery 32 being maintained equal to or greater than the flyable charge amount, the determinations in steps S120 to S124 all become positive, and the flight is permitted by the control section 91 in step S128. Upon that permission, after completion of the flight check, the flight of the aircraft 100 will be started with the operation by the crew. In this manner, the determination in step S129 becomes positive, and the present flow S100 ends.

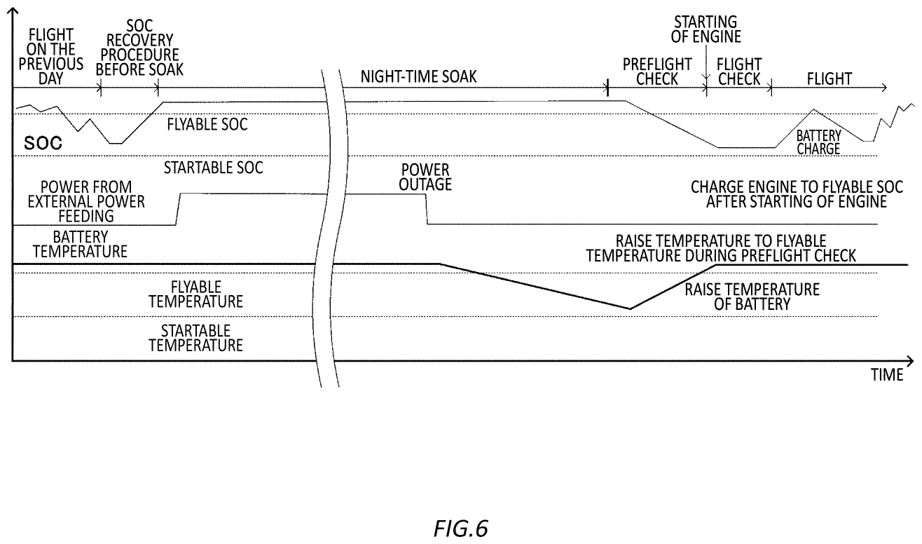

FIG. 6 illustrates an example of the temperature control on the battery 32 at the time of a first abnormality when power feeding from the external power source 111 has been lost. The state of charge of the battery 32 is recovered before soaking (stopping the engine 44), and the engine 44 is stopped while connecting the external power source 111 to the temperature adjusting apparatus 71 of the aircraft 100, thereby entering the night-time soak. However, in the present example, the external power source 111 is lost and power feeding has been stopped due to power outage during the night-time soak. After this, the temperature of the battery 32 will gradually decrease. During this night-time soak, with the determination in step S110 being negative and the determination in step S112 being negative in the flow S100, steps S130 to S144 and S150 to S152 will be repeated. In this manner, the temperature of the battery 32 is maintained equal to or higher than the flyable temperature, and the charged power of the battery 32 is maintained equal to or greater than the startable charge amount. Note that a self-discharge of the battery 32 can be ignored.

Before starting the preflight check, with the determinations in steps S110, S112, S130, S150 repeatedly being negative, the temperature of the battery 32 will continue to decrease without taking any measure. In the present example, the temperature of the battery 32 is assumed to be decreased to a temperature that is lower than the flyable temperature but is higher than the startable temperature, at the time of starting the preflight check.

Furthermore, with the preflight check being started, the determination in step S130 becomes positive, and the process shifts to step S132. Note that, at the time of starting the preflight check, the external power source 111 is removed from the aircraft 100 (the temperature adjusting apparatus 71). Here, with the charged power of the battery 32 being maintained equal to or greater than the flyable charge amount while the temperature of the battery 32 being lower than the flyable temperature, the determination in step S132 becomes positive, the determination in step S134 becomes negative, and the determination in step S136 becomes positive, and the battery 32 is warmed using the charged power of the battery 32 by the temperature adjusting apparatus 71 in step S140. In this manner, although the charged power of the battery 32 decreases, the temperature of the battery 32 is raised.

Furthermore, although the charged power of the battery 32 decreases to the startable charge amount, the temperature of the battery 32 is raised to a temperature that is equal to or higher than the flyable temperature during the preflight check. In this manner, the determination in step S134 becomes positive, and the battery 32 is kept warm by the temperature adjusting apparatus 71 using the charged power of the battery 32 in step S138. In this manner, with the charged power of the battery 32 being maintained equal to or greater than the startable charge amount and the temperature of the battery 32 being maintained equal to or higher than the startable temperature, the determination in step S150 becomes positive, and the start of the engine 44 is permitted in step S152. Upon that permission, after completion of the preflight check (the system check), the engine 44 will be started by the crew.

Furthermore, once the engine 44 has been started, the determination in step S110 becomes positive, and the process shifts to step S120. Here, with the temperature of the battery 32 being maintained equal to or higher than the flyable temperature, the determination in step S120 becomes positive, and with the charged power of the battery 32 being less than the flyable charge amount, the determination in step S124 becomes negative, and the battery 32 is charged while being kept warm by the temperature adjusting apparatus 71 using the power generated by the engine 44 in step S126. In this manner, with the charge amount of the battery 32 being recovered to an amount that is equal to or greater than the flyable charge amount, the determination in step S124 becomes positive, and the flight is permitted by the control section 91 in step S128. Upon that permission, after completion of the flight check, the flight of the aircraft 100 will be started with the operation by the crew. In this manner, the determination in step S129 becomes positive, and the present flow S100 ends.

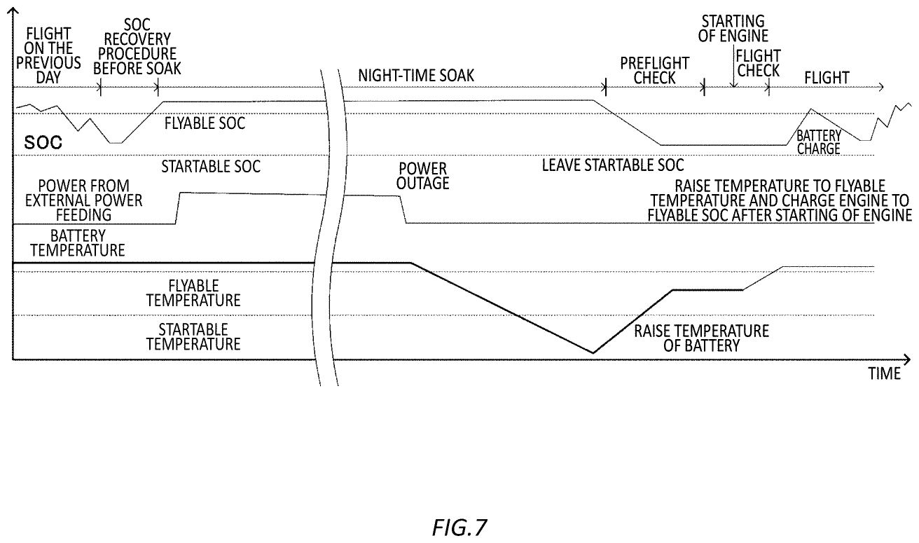

FIG. 7 illustrates an example of the temperature control on the battery 32 at the time of a second abnormality when power feeding from the external power source 111 has been lost. The state of charge of the battery 32 is recovered before soaking (stopping the engine 44), and the engine 44 is stopped while connecting the external power source 111 to the temperature adjusting apparatus 71 of the aircraft 100, thereby entering the night-time soak. However, in the present example, the external power source 111 is lost and power feeding has been stopped due to power outage during the night-time soak. After this, the temperature of the battery 32 will gradually decrease. During this night-time soak, with the determination in step S110 being negative and the determination in step S112 being negative in the flow S100, steps S130 to S144 and S150 to S152 will be repeated. In this manner, the temperature of the battery 32 is maintained equal to or higher than the startable temperature, and the charged power of the battery 32 is maintained equal to or greater than the startable charge amount. Note that a self-discharge of the battery 32 can be ignored.

Before starting the preflight check, with the determinations in steps S110, S112, S130, S150 repeatedly being negative, the temperature of the battery 32 will continue to decrease without taking any measure. In the present example, the temperature of the battery 32 is assumed to be decreased to a temperature that is lower than the flyable temperature, and further lower than the startable temperature, at the time of starting the preflight check.

Furthermore, with the preflight check being started, the determination in step S130 becomes positive, and the process shifts to step S132. Note that, at the time of starting the preflight check, the external power source 111 is removed from the aircraft 100 (the temperature adjusting apparatus 71). Here, with the charged power of the battery 32 being maintained equal to or greater than the flyable charge amount while the temperature of the battery 32 being lower than the startable temperature (i.e., the flyable temperature), the determination in step S132 becomes positive, the determination in step S134 becomes negative, and the determination in step S136 becomes positive, and the battery 32 is warmed using the charged power of the battery 32 by the temperature adjusting apparatus 71 in step S140. In this manner, although the charged power of the battery 32 decreases, the temperature of the battery 32 is raised.

Furthermore, the charged power of the battery 32 decreases to the startable charge amount, and the temperature of the battery 32 is raised to a temperature that is equal to or higher than the startable temperature during the preflight check. However, with the temperature of the battery 32 being lower than the flyable temperature, the determination in step S134 becomes negative. Here, as long as the determination in step S136 continues to be positive, the temperature adjusting apparatus 71 continues to warm the battery 32 using the charged power of the battery 32 in step S140. By using the battery 32, the charge amount of the battery 32 becomes lower than the sum of the startable charge amount and the charge amount required to raise the temperature, and even if the determination in step S136 becomes negative, with the charged power of the battery 32 being maintained at the startable charge amount and the temperature of the battery 32 being raised to a temperature that is equal to or higher than the startable temperature, the determination in step S142 becomes positive, and the battery 32 is kept warm by the temperature adjusting apparatus 71 using the charged power of the battery 32 in step S138. In this manner, with the charged power of the battery 32 being maintained equal to or greater than the startable charge amount and the temperature of the battery 32 being maintained equal to or higher than the startable temperature, the determination in step S150 becomes positive, and the start of the engine is permitted in step S152. Upon that permission, after completion of the preflight check (the system check), the engine 44 will be started by the crew.

Furthermore, once the engine 44 has been started, the determination in step S110 becomes positive, and the process shifts to step S120. The battery 32 is warmed while being charged by the temperature adjusting apparatus 71 using the power generated by the engine 44 in step S122, until the determination in step S120 becomes positive, that is, the temperature becomes equal to or higher than the flyable temperature. In this manner, once the temperature of the battery 32 is raised to a temperature that is equal to or higher than the flyable temperature, the battery 32 is kept warm while being charged by the temperature adjusting apparatus 71 using the power generated by the engine 44 in step S126, until the determination in step S124 becomes positive, that is, charging is performed to an amount that is equal to or greater than the flyable charge amount. In this manner, once the charge amount of the battery 32 is recovered to an amount that is equal to or greater than the flyable charge amount, the determination in step S124 becomes positive, and the flight is permitted by the control section 91 in step S128. Upon that permission, after completion of the flight check, the flight of the aircraft 100 will be started with the operation by the crew. In this manner, the determination in step S129 becomes positive, and the present flow S100 ends.

Note that, if the charged power of the battery 32 falls below the startable charge amount before the temperature of the battery 32 is raised to the startable temperature, the determination in step S132 or step S142 becomes negative, and the flight is restricted in step S144, thereby ending the flow S100.

According to the temperature control system 70 of the present embodiment, in the aircraft 100 which flies utilizing the power generated by the engine 44 or the power charged in the battery 32, the temperature control system 70 includes the battery 32 which stores power for starting the engine 44 and flying, the temperature adjusting apparatus 71 which warms and keeps the warmth of the battery 32 by each of at least the power charged in the battery 32 and power feeding from the external power source 111, and the control section 91 which detects the presence or absence of power feeding from the external power source 111, and if the power feeding from the external power source 111 is present, controls the temperature adjusting apparatus 71 to warm or keep the warmth of the battery 32 using the power feeding from the external power source 111, and if the power feeding from the external power source 111 is absent, controls the temperature adjusting apparatus 71 based on the temperature state and the state of charge of the battery 32 to warm or keep the warmth of the battery 32 using the charged power of the battery 32. In this manner, the control section 91 detects the presence or absence of power feeding from the external power source 111, and if the power feeding from the external power source 111 is present, controls the temperature adjusting apparatus 71 to warm or keep the warmth of the battery 32 using the power feeding from the external power source 111, and if the power feeding from the external power source 111 is absent, controls the temperature adjusting apparatus 71 based on the temperature state and the state of charge of the battery 32 to warm or keep the warmth of the battery 32 using the charged power of the battery 32, thereby allowing to maintain the temperature and the state of charge of the battery 32 enabling the engine to start and fly at departure. In this manner, even if power feeding from the external power source 111 has been stopped, it is possible to start the engine of the aircraft 100 and cause it to fly in accordance with the schedule.

According to the temperature control method of the present embodiment, in the aircraft 100 which flies utilizing the power generated by the engine 44 or the power charged in the battery 32, the temperature control method includes the steps of detecting the presence or absence of power feeding from the external power source 111, warming or keeping the warmth of the battery 32 which stores power for starting the engine 44 and flying using power feeding from the external power source 111 if the power feeding from the external power source 111 is present, and warming or keeping the warmth of the battery 32 using the charged power of the battery 32 based on the temperature state and the state of charge of the battery 32 if the power feeding from the external power source 111 is absent. In this manner, the control section 91 detects the presence or absence of power feeding from the external power source 111, and if the power feeding from the external power source 111 is present, controls the temperature adjusting apparatus 71 to warm or keep the warmth of the battery 32 using the power feeding from the external power source 111, and if the power feeding from the external power source 111 is absent, controls the temperature adjusting apparatus 71 based on the temperature state and the state of charge of the battery 32 to warm or keep the warmth of the battery 32 using the charged power of the battery 32, thereby allowing to maintain the temperature and the state of charge of the battery 32 enabling the engine to start and fly at departure. In this manner, even if power feeding from the external power source 111 has been stopped, it is possible to start the engine of the aircraft 100 and cause it to fly in accordance with the schedule.

While the embodiments of the present invention have been described, the technical scope of the present invention is not limited to the above-described embodiments. It is apparent to persons skilled in the art that various alterations or improvements can be made to the above-described embodiments. It is also apparent from the scope of the claims that the embodiments added with such alterations or improvements can also be included in the technical scope of the present invention.

The operations, procedures, steps, stages, or the like of each process performed by an apparatus, system, program, and method shown in the claims, specification, or drawings can be performed in any order as long as the order is not specified by a phrase “prior to,” “before,” or the like and as long as the output from a previous process is not used in a later process. Even if an operation flow is described using phrases such as “firstly” or “secondly” in the claims, specification, or drawings, it does not mean that the process must be performed in this order.

What is claimed is:

1. A temperature control system for controlling, in an aircraft that flies utilizing power generated by an engine or power charged in an internal power source, a temperature of the internal power source, comprising:
the internal power source configured to store power for starting an engine and flying;
a temperature adjusting unit configured to adjust the temperature of the internal power source by warming, cooling, or keeping warmth of the internal power source by each of at least the power charged in the internal power source and power feeding from an external power source; and
a control section configured to detect presence or absence of the power feeding from the external power source to:
if the power feeding from the external power source is present, control the temperature adjusting unit to adjust the temperature of the internal power source using the power feeding from the external power source; and
if the power feeding from the external power source is absent, control the temperature adjusting unit based on a temperature state and a state of charge of the internal power source to adjust the temperature of the internal power source using charged power of the internal power source.

2. The temperature control system according to claim 1, wherein the control section is configured to, if the power feeding from the external power source is absent, control the temperature adjusting unit to warm the internal power source using the charged power of the internal power source, in response to the charged power of the internal power source before a time that is predetermined from an expected time of departure or after the time being equal to or greater than a startable charge amount needed to start the engine and the temperature of the internal power source being lower than a flyable temperature needed to fly the aircraft.

3. The temperature control system according to claim 2, wherein the control section is configured to control the temperature adjusting unit to warm the internal power source using the charged power of the internal power source, in response to the charged power of the internal power source being equal to or greater than a sum of the startable charge amount and power needed to raise the temperature of the internal power source to at least a startable temperature enabling the engine to start.

4. The temperature control system according to claim 2, wherein the control section is configured to, if the power feeding from the external power source is absent, control the temperature adjusting unit to keep the warmth of the internal power source using the charged power of the internal power source, in response to the temperature of the internal power source being equal to or higher than the flyable temperature.

5. The temperature control system according to claim 3, wherein the control section is configured to, if the power feeding from the external power source is absent, control the temperature adjusting unit to keep the warmth of the internal power source using the charged power of the internal power source, in response to the temperature of the internal power source being equal to or higher than the flyable temperature.

6. The temperature control system according to claim 2, wherein the control section is configured to give a signal for restricting a flight of the aircraft, in response to the charged power of the internal power source being less than the startable charge amount.

7. The temperature control system according to claim 3, wherein the control section is configured to give a signal for restricting a flight of the aircraft, in response to the charged power of the internal power source being less than the startable charge amount.

8. The temperature control system according to claim 2, wherein the control section is configured to, if the power feeding from the external power source is absent, control the temperature adjusting unit to cool the internal power source using the charged power of the internal power source, in response to the temperature of the internal power source being equal to or higher than an upper limit temperature of the internal power source.

9. The temperature control system according to claim 3, wherein the control section is configured to, if the power feeding from the external power source is absent, control the temperature adjusting unit to cool the internal power source using the charged power of the internal power source, in response to the temperature of the internal power source being equal to or higher than an upper limit temperature of the internal power source.

10. The temperature control system according to claim 2, wherein
the control section is configured to, if the power feeding from the external power source is present, further detect whether the temperature of the internal power source is equal to or higher than the flyable temperature to:
if the temperature of the internal power source is equal to or higher than the flyable temperature, control the temperature adjusting unit to keep the warmth of the internal power source using the power feeding from the external power source; and
if the temperature of the internal power source is lower than the flyable temperature, control the temperature adjusting unit to warm the internal power source using the power feeding from the external power source.

11. The temperature control system according to claim 3, wherein
the control section is configured to, if the power feeding from the external power source is present, further detect whether the temperature of the internal power source is equal to or higher than the flyable temperature to:
if the temperature of the internal power source is equal to or higher than the flyable temperature, control the temperature adjusting unit to keep the warmth of the internal power source using the power feeding from the external power source; and
if the temperature of the internal power source is lower than the flyable temperature, control the temperature adjusting unit to warm the internal power source using the power feeding from the external power source.

12. The temperature control system according to claim 10, wherein the control section is configured to, if the power feeding from the external power source is present, control the temperature adjusting unit to cool the internal power source using the power feeding from the external power source, in response to the temperature of the internal power source being equal to or higher than an upper limit temperature of the internal power source.

13. The temperature control system according to claim 2, wherein the control section is configured to start the engine if the temperature of the internal power source is equal to or higher than a startable temperature enabling the engine to start, and the charged power of the internal power source is equal to or greater than the startable charge amount.

14. The temperature control system according to claim 3, wherein the control section is configured to start the engine if the temperature of the internal power source is equal to or higher than a startable temperature enabling the engine to start, and the charged power of the internal power source is equal to or greater than the startable charge amount.

15. The temperature control system according to claim 13, wherein
the control section is configured to, during running of the engine, further detect whether the temperature of the internal power source is equal to or higher than the flyable temperature to:
if the temperature of the internal power source is equal to or higher than the flyable temperature, control the temperature adjusting unit to keep the warmth of the internal power source using power generated by the engine; and
if the temperature of the internal power source is lower than the flyable temperature, control the temperature adjusting unit to warm the internal power source using the power generated by the engine.

16. The temperature control system according to claim 15, wherein the control section is configured to, during the running of the engine, further charge the internal power source using the power generated by the engine.

17. The temperature control system according to claim 15, wherein the control section is configured to, if the temperature of the internal power source is equal to or higher than an upper limit temperature of the internal power source, control the temperature adjusting unit to cool the internal power source using the power generated by the engine.

18. The temperature control system according to claim 15, wherein the control section is configured to:
during the running of the engine, further detect whether the charged power of the internal power source is equal to or greater than a flyable charge amount needed to fly the aircraft; and
if the temperature of the internal power source is equal to or higher than the flyable temperature and the charged power of the internal power source is equal to or greater than the flyable charge amount, give a signal for permitting a flight.

19. An aircraft comprising the temperature control system according to claim 1.

20. A temperature control method for controlling, in an aircraft that flies utilizing power generated by an engine or power charged in an internal power source, a temperature of the internal power source, comprising:
detecting presence or absence of power feeding from an external power source;
if the power feeding from the external power source is present, warming, cooling, or keeping warmth of an internal power source which is configured to store power to start an engine and fly, using the power feeding from the external power source; and
if the power feeding from the external power source is absent, warming, cooling, or keeping the warmth of the internal power source using charged power of the internal power source based on a temperature state and a state of charge of the internal power source.
